(19) United States
(12) Patent Application Publication
(10) Pub. No.: US 2015/0101736 A1
(43) Pub. Date: Apr. 16, 2015

(54) Method of Manufacturing Laminated Glass for Vehicle

(71) Applicant: Central Glass Company, Limited, Ube-shi (JP)

(72) Inventors: Kensuke IZUTANI, Matsusaka-shi (JP); Satoshi NISHIYAMA, Matsusaka-shi (JP); Kentaro IBI, Matsusaka-shi (JP); Naoya MORI, Matsusaka-shi (JP)

(21) Appl. No.: 14/510,765

(22) Filed: Oct. 9, 2014

(30) Foreign Application Priority Data
Oct. 10, 2013 (JP) 2013-213131
Sep. 19, 2014 (JP) 2014-190690

(51) Int. Cl. B60J 1/00; C03C 27/10

(52) U.S. Cl. CPC B60J 1/001; C03C 27/10
USPC 156/104

(57) ABSTRACT

A method of manufacturing a vehicle laminated glass according to the present invention includes: stacking a thermal insulating film between two resin intermediate films; stacking these films between two curved glass plates, thereby forming a stacked body; degassing the stacked body; and, after the degassing, thermocompression bonding the stacked body by pressing and heating up to a maximum temperature of 120 to 150° C., wherein: the thermal insulating film has a heat shrinkage of 0.9 to 5% in a temperature range of 120 to 150° C.; the resin intermediate film is larger in area than the glass plates; and the stacked body is formed such that an edge part of the resin intermediate film protrudes outwardly by 1 mm or more from edges of the glass plates. It is possible by this method to prevent an appearance defect in the thermal insulating film throughout the entire circumference of the laminated glass.

### FIELD OF THE INVENTION

The present invention relates to a method of manufacturing a laminated glass for a vehicle, in which a thermal insulating film is arranged between glass plates.

### BACKGROUND OF THE INVENTION

A laminated glass for a vehicle has a film of PVB resin or the like between two curved glass plates. In recent years, there have been made researches to arrange a thermal insulating film between the glass plates of the laminated glass for the purpose of imparting thermal insulation properties to the laminated glass and thereby preventing a temperature rise in the interior of the vehicle.

In general, the vehicle laminated glass is manufactured by laminating the vehicle-exterior-side glass plate, the resin intermediate film, the thermal insulating film, the resin intermediate film and the vehicle-interior-side glass plate in order of mention. In this lamination process, the above structural components are stacked together and then subjected to thermocompression bonding under high-temperature/high-pressure conditions in an autoclave. Due to the use of the curved glass plates, however, there is a problem of wrinkles or crinkles occurring in the thermal insulating film at a location between circumferential edge parts of the glass plates.

As a solution to such a problem, Patent Document 1 focuses attention on the fact that wrinkles occur in a thermal insulating film by the deformation of a redundant part of the thermal insulating film in the vicinity of circumferential edges of glass plates and proposes, in the manufacturing of a laminated glass, to use a thermal insulating film such that, on at least one side of the thermal insulating film, an edge of the thermal insulating film is situated apart from edges of glass plates by a distance of 5 mm to 200 m toward the center of the glass plates so as to eliminate in advance a part of the thermal insulating film in which wrinkles are likely to occur. Patent Document 2 proposes, as a technique for preventing the occurrence of wrinkles in a thermal insulating film during the manufacturing of a laminated glass, to provide a laminated film by thermocompression bonding a resin insulating film to the thermal insulating film under a tension and arranging another resin insulating film on the thermal insulating film, stack the laminated film between glass plates, bond the resulting stacked body by pressing and heating, and then, cut off a redundant part of the laminated film protruding from edges of the glass plates.

On the other hand, the use of a heat-shrinkable film as the thermal insulating film has been proposed to prevent wrinkles or crinkles from occurring in the thermal insulating film at a location between circumferential edge parts of the glass plates without the application of a tension to the thermal insulating film as in the above document.

For example, Patent Document 3 proposes, in the manufacturing of a laminated glass, to use a plastic film formed with a thermal insulating coating of indium oxide or silver and having a heat shrinkage of 1 to 20% during thermal processing.

Patent Document 4 proposes, in the manufacturing of a laminated glass, to use as a plastic film a multilayer resin film having an average heat shrinkage change rate of 0.01%/° C. or higher is measured by thermomechanicai analysis in one arbitrary direction parallel to a film surface of the multilayer resin film in a temperature range of 100 to 150° C. and a heat shrinkage of 0.3 to 3% at a temperature of 150° C.

Patent Document 5 proposes a laminated glass using a thermal insulating film having a heat shrinkage of 0.5 to 3% in a temperature range of 90 to 150° C. so as to prevent the occurrence of an appearance defect such as wrinkles. This laminated glass is manufactured by stacking a plastic film with an infrared reflective coating as the thermal insulating film and resin intermediate films between glass plates, cutting off redundant parts of the plastic film and the resin intermediate films protruding from edges of the glass plates, and then, bonding the resulting stacked body by pressing and heating.

### Prior Art Documents

### Patent Document 1: Japanese Laid-Open Patent Publication No. 2009-161407

### Patent Document 2: Japanese Laid-Open Patent Publication No. 2009-161406

Patent Document 3: Japanese Laid-Open Patent Publication No. H06-270318

### Patent Document 4: Japanese Laid-Open Patent Publication No. 2012-81748

### Patent Document 5: Japanese Laid-Open Patent Publication No. 2010-180089

### SUMMARY OF THE INVENTION

In the manufacturing of the vehicle laminated glass in which the thermal insulating film is arranged between the glass plates, it is effective to use the heat-shrinkable film as the thermal insulating film for the prevention of an appearance defect such as wrinkles as mentioned above.

There however arises a new problem that the resin intermediate films are contracted toward the center of the vehicle laminated glass as an edge of the thermal insulating film gets inside edges of the glass plates by shrinkage of the heat-shrinkable thermal insulating film during lamination. This problem results in the formation of a depression in an edge part of the vehicle laminated glass and causes a serious appearance defect around the entire circumference of the vehicle laminated film. In the above state, there also arises a new problem that the resin intermediate film gets colored by heat or light.

In view of the foregoing, it is an object of the present invention to provide a laminated glass for a vehicle, having a heat-shrinkable thermal insulating film without causing an appearance defect throughout the entire circumference of the laminated glass.

The present inventors have made extensive researches and consequently found that, in the case of manufacturing a laminated glass by using a heat-shrinkable thermal insulating film having a heat shrinkage of 0.9 to 5% in a temperature range of 120 to 150° C. and laminating the thermal insulating film between glass plates via resin intermediate films, the resin intermediate films are contracted toward the center of the glass plates to form a depression between edge parts of the glass plates as shown in FIG. 1B after the thermocompression bonding even though the respective structural components of the laminated glass are aligned before thermocompression bonding as shown in FIG. 1A. The strength of the glass plates deteriorates when the depression is formed between the edge parts of the glass plates. As a result, it becomes likely that the glass plates will be cracked or chipped. The present invention is based on such a finding.

Namely, there is provided according to a first aspect of the present invention a method of manufacturing a laminated glass for a vehicle, comprising: stacking a thermal insulating film between two resin intermediate films; stacking the thermal insulating film and the resin intermediate films between two curved glass plates, thereby forming a stacked body; degassing the stacked body; and, after the degassing, subjecting the stacked body to thermocompression bonding by pressing and heating up to a maximum temperature of 120 to 150° C., wherein the thermal insulating film has a heat shrinkage of 0.9 to 5% in a temperature range of 120 to 150° C.; wherein the resin intermediate film is larger in area than the glass plates; and wherein the stacked body is formed such that an edge part of the resin intermediate film protrudes outwardly by 1 mm or more from edges of the glass plates.

The expression “the edge part of the resin intermediate film protrudes outwardly by 1 mm or more from the edges of the glass plates” refers to the configuration where the resin intermediate film is larger in area than the glass plates such that, when the resin intermediate film is stacked between the glass plates, the distance d from an edge of the resin intermediate film to the edges of the glass plates is 1 mm or more as shown in FIG. 2. The resin intermediate film may protrude in one direction from between the glass plates. Alternatively, the resin intermediate film may protrude in all directions from between the glass plates throughout the entire circumference of the stacked body. The effects of the present invention can be expected even when the amount of protrusion of the resin intermediate film is less than 1 mm. There is however a possibility of difficulty in stable manufacturing and deterioration in manufacturing yield when the amount of protrusion of the resin intermediate film is less than 1 mm. There is no particular limitation on the upper limit of the amount of protrusion of the resin intermediate film as long as the resin intermediate film does not hang down during lamination. For example, the amount of protrusion of the resin intermediate film may be set to be 20 mm or less.

The stacked body is subjected to thermocompression bonding by pressing the stacked body while heating the stacked body up to a maximum temperature of 120° C. to 150° C. and maintaining the stacked body at around the maximum temperature for about 20 to 40 minutes. In this bonding operation, the above-mentioned defect could occur as the stacked body gets exposed to high-temperature/high-pressure conditions. Thus, the thermal insulating film used herein has a heat shrinkage of 0.9 to 5% in a temperature range of 120° C. to 150° C.

Herein, the heat shrinkage can of the thermal insulating film be determined by the following procedure according to JIS C 2151 (2006).

A rectangular film sample of 150 mm in length and 40 mm in width is cut out from the thermal insulating film. Using a diamond pen, reference marks are indicated at around the center of the rectangular film sample in a width direction with a distance of about 100 mm left therebetween. After that, the rectangular film sample is divided into two equal sample pieces of 150 mm×20 mm in size. One of the sample pieces is vertically hung in a hot-air circulation thermostat oven, heated to a measurement temperature of 120° C. to 150° C. at a temperature increase rate of about 5° C./min, and then, maintained at the measurement temperature for about 20 minutes. The hot-air circulation thermostat oven is then opened to the air so that the heated sample piece is subjected to natural cooling at a cooling rate of about 20° C./min and maintained at room temperature for 30 minutes. The above temperature measurements can be carried out with a thermocouple thermometer. The distribution of the temperature inside the hot-air circulation thermostat oven can be set to within ±1° C. On the other hand, the other sample piece is maintained at room temperature. The distances L1, L2 between the reference marks on the sample pieces, one of which has been maintained at room temperature and the other of which has been heated at the measurement temperature, is measured with a scanning laser microscope (“1LM21D” manufactured by Lasertec Corporation). The heat shrinkage (%) is determined according to the following equation: (L1−L2)×100/L1. In the present invention, three film samples are cut out for each of the flow direction (hereinafter also referred to as “MD direction”) and the width direction (hereinafter also referred to “TD direction”) of the film; and the heat shrinkage is determined as an average value of the heat shrinkage measurement results of these three film samples.

Although the heat shrinkage of the thermal insulating film in the MD direction may be different from the heat shrinkage of the thermal insulating film in the TD direction, the abovementioned defect could occur as long as the heat shrinkage of the thermal insulating film in at least one direction is 0.9 to 5% in the temperature range of 120 to 150° C.

There is provided according to a second aspect of the present invention a method of manufacturing a laminated glass for a vehicle, comprising; stacking a thermal insulating film between two resin intermediate films; stacking the thermal insulating film and the resin intermediate films between two curved glass plates, thereby forming a stacked body; degassing the stacked body; and, after the degassing, subjecting the stacked body to thermocompression bonding by pressing and heating up to a maximum temperature of 120° C. to 150° C., wherein the method further comprises, after the forming of the stacked body, heating the stacked body at 100° C. or lower; wherein the degassing is performed by means of rolls after the heating and before the thermocompression bonding; wherein the thermal insulating film has a heat shrinkage of 0.9 to 5% in a temperature range of 120 to 150° C.; wherein the resin intermediate film is larger in area than the glass plates; and wherein the stacked body is formed such that: an edge of the resin intermediate film in a transfer direction relative to the rolls protrudes outwardly by 1 to 10 mm from corresponding edges of the glass plates; and edges of the resin intermediate film in any directions other than the transfer direction protrude outwardly by 1 to 20 mm from corresponding edges of the glass plates.

In the second aspect, the stacked body is degassed by pressing with the rolls after the whole of the stacked body is heated at 100° C. or lower. Namely, the heated stacked body is pressed in the degassing step. This enables preliminary bonding of the stacked body before the subsequent thermocompression bonding step.

In the degassing step, a part of the resin intermediate film protruding from the glass plates in the transfer direction relative to the rolls is softened by heating. If the amount of protrusion of the resin intermediate film is too large, the softened part of the resin intermediate film hangs down and gets caught in the rolls or extruded to the back of the glass plate to cause an appearance defect. It is thus preferable that:, in the case where the degassing step is performed by means of the rolls, the edge of the resin intermediate film in the transfer direction relative to the rolls protrudes outwardly from the corresponding edges of the glass plates by 1 to 10 mm; and the edges of the resin intermediate film in any directions other than the transfer direction protrude from the corresponding edges of the glass plates by 20 mm or less, more preferably 15 mm or less. Alternatively, the resin intermediate film may protrude outwardly by 10 mm or less from between the glass plates throughout the entire circumference of the stacked body.

It is therefore possible according to the present invention to provide the vehicle laminated glass having the heat-shrinkable thermal insulating film with the occurrence of no appearance defect throughout the entire circumference of the laminated glass.

### BRIEF DESCRIPTION OF DRAWINGS

FIGS. 1A and 1B are schematic views respectively showing the state of a staked body after a stacking step and before and after a subsequent thermocompression bonding step, according to the conventional art.

FIG. 2 is schematic view showing a stacked body after a stacking step, as viewed from a direction perpendicular to surfaces of glass plates, according to one embodiment of the present invention.

FIGS. 3A and 3B are schematic views respectively showing the state of the stacked body before and after being subjected to a thermocompression bonding step in the case where the stacked body is formed such that an edge part of one resin intermediate film protrudes from edges of the glass plates.

FIGS. 4A and 4B are schematic views respectively showing the state of the stacked body before and after being subjected to a thermocompression bonding step in the case where the stacked body is formed such that a thermal insulating film is provided with an inclined cut edge.

FIG. 5A is a schematic view showing a degassing step in which a stacked body is degassed by means of rolls according to another embodiment of the present invention.

FIG. 5B is a schematic view showing the case where a resin insulating film is extruded to the back of a glass plate during the degassing step.

FIG. 5C is a schematic view showing an example of the arrangement of the rolls in the degassing step.

FIGS. 6A and 6B are schematic views respectively showing the state of a stacked body before and after being subjected to a thermocompression bonding step, in the case where the stacked body is formed such that edge parts of a thermal insulating film and resin intermediate films protrude from edges of glass plates, in Example 1.

FIGS. 7A and 7B are schematic views respectively showing the state of a stacked body, as before and after being subjected to a thermocompression bonding step, in the case where the stacked body is formed such that edge parts of a the insulating film and resin intermediate films protrude from edges of glass plates, in Example 2.

FIG. 8 is a schematic view showing a stacked body in Example 3.

FIG. 9 is a schematic view showing edge parts of resin intermediate films in Example 4.

### DESCRIPTION OF EMBODIMENTS

The respective structural components of the vehicle laminated glass of the present invention will be first described below.

In the present invention, the thermal insulating film combines a heat shrinkage of 0.9 to 5% in a temperature range of 120 to 150° C. with thermal insulation properties. If the heat shrinkage of the thermal insulating film is lower than 0.9%, wrinkles are likely to occur in the thermal insulating film as mentioned above. If the heat shrinkage of the thermal insulating film is higher than 5%, it may be impossible to prevent the formation of a depression between edge parts of the glass plates. The lower limit of the heat shrinkage may preferably be set to 1%, more preferably 2%. The effects of the present invention becomes more pronounced when the heat shrinkage exceeds 3%. Thus, the heat shrinkage may preferably be set to be higher than 3%. The term “heat shrinkage” used herein refers to that in at least one of MD and TD directions.

In the present specification, the term “thermal insulation properties” refer to the ability of reflecting or absorbing thermal radiation such as near-infrared radiation and can be generally expressed by total solar transmittance (Ts) according to ISO 13837 (2008) or solar heat gain coefficient according to JIS R 3106. The thermal insulating film used in the present invention is selected on the basis of T_{TS}. The lower the total solar transmittance T_{TS}, the better the thermal insulation properties. In order for the thermal insulating film to exhibit good thermal insulation properties, the total solar transmittance T_{TS} of the thermal insulating film is preferably 50% or lower, more preferably 47%. There is no particular limitation on the lower limit of the total solar transmittance T_{TS}. There would be no problem even when the total solar transmittance T_{TS} of the thermal insulating film is set to be 40% or higher.

In the case where the vehicle laminated glass of the present invention is used as a front glass or front side glass for a vehicle, the visible light transmittance of the vehicle laminated glass may preferably be set to be 70% or higher according to JIS R 3121 in order to secure the visibility of a vehicle driver.

The thermal insulating film can be in the form of a heat-shrinkable substrate film having on one or both of surfaces thereof a thermal insulating coating or layer. Alternatively, the thermal insulating film can be provided as a laminated film of thermal insulating thin film sheets, a thermal insulating coating, a laminated film of thermal insulating coatings etc. without using the substrate film.

In the case where the substrate film is used for the thermal insulating film, there is no particular limitation on the substrate film as long as the substrate film is heat shrinkable. Examples of such a heat-shrinkable substrate film are those of polyethylene terephthalate, polyethylene naphthalate, polycarbonate, polymethyl methacrylate, polyethersulfone, nylon, polyarylate, cycloolefin polymer and the like. Particularly preferred is a crystalline polyethylene terephthalate film (PET film) formed by biaxial stretching because the crystalline polyethylene terephthalate film has not only high heat resistance for use in a wide operating temperature range but also high transparency and stable mass-production quality. As a technique to impart heat shrinkage to the substrate film, it is conceivable to subject the raw material film to biaxial stretching at a temperature higher than the glass transition temperature of the film and then to thermal fixing.

There is also no particular limitation on the thermal insulating coating or layer as long as the thermal insulating coating or layer has thermal insulation properties and does not significantly deteriorate during lamination. Examples of such a thermal insulating coating or layer are: a multilayer coating formed by laminating two or more kinds of dielectric thin coating layers of different refractive indexes; a laminated coating of polarizing liquid crystal layers; a metal coating; and a laminated coating of metal coating layers. In particular, a multilayer coating of dielectric thin coating layers or a laminated coating of liquid crystal layers can suitably be used without the substrate film by appropriate selection of the coating thickness and material.

In the case where the coating is formed on the substrate film, there is a possibility of crack of the coating, or curl of the thermal insulating film by the bimetallic effect under heating, depending on the thickness and heat shrinkage of the substrate film. The curl of the thermal insulating film does not become a problem of quality, but causes a difficulty of handling. It is preferable to use an adhesive between the substrate film and the coating in order to prevent crack of the coating. In order to prevent curl of the film, it is preferable to apply a coating or layer on both surfaces of the substrate film. This coating may have thermal insulation properties, or may not have thermal insulation properties, like a coating of silane coupling agent etc. for improvement of adhesion.

In the case where the laminated film of thermal insulating thin film sheets is used as the thermal insulating film without the substrate film, preferred is a multilayer film in which polymer thin film sheets of different refractive indexes are alternately laminated together. The polymer thin film sheets are preferably selected from those of polyethylene terephthalate, polyethylene naphthalate, polymethyl methacrylate, polyethylene, polystyrene, polycarbonate, polyvinylidene fluoride-polymethyl methacrylate mixture, ethylene-unsaturated monocarboxylic acid copolymer, styrene-methyl methacrylate copolymer and the like. The multilayer film can be subjected to biaxial stretching for improvement of mechanical strength, heat shrinkage, chemical resistance, transparent etc. as needed and thus can suitably be used as the heat-shrinkable film.

It is preferably that the thermal insulating film has a thickness of 30 to 200 μm. If the thickness of the thermal insulating film is out of the above range, there arises a problem such as poor degassing during the manufacturing of the vehicle laminated glass or distorted perspective image on the resulting vehicle laminated glass. The thickness of the thermal insulating film may preferably be set to be 50 to 150 μm.

In the present invention, films of hot-melt adhesive such as polyvinyl butyral (PVB), ethylene vinyl acetate (EVA) or the like are preferred as the resin intermediate films. It is feasible to partly color the resin intermediate film, to embed a sound insulating layer in the resin intermediate film, to form the resin intermediate film with a thickness gradient or to perform embossing surface treatment on the resin intermediate film. An ultraviolet absorbent, an antioxidant, an antistatic agent, a heat stabilizer, a coloring agent, an adhesion improver etc. may be added into the resin intermediate films as appropriate. It is particularly preferable to add infrared-absorbing fine particles into the resin intermediate films for the manufacturing of the high-performance thermal insulating laminated glass.

The glass plates are formed into a curved shape with three-dimensionally convex- and concave-curved surfaces in the present invention. In general, the glass plates have a curvature radius of 0.5 to 3 m, preferably 0.9 to 2.6 m. The curvature radius may be different between the center and circumferential edge parts of these three-dimensionally curved glass plates. In such a case, the circumferential edge parts of the glass plates are generally smaller in curvature radius than that of the center of the glass plates. Further, the curvature radius may be different between vertical and horizontal directions of the glass plates.

Next, the manufacturing method of the vehicle laminated glass according to the first embodiment of the present invention will be described below.

The manufacturing method of the vehicle laminated glass according to the first embodiment of the present invention includes: stacking the thermal insulating film between the two resin intermediate films; stacking the thermal insulating film and the resin intermediate films between the two curved glass plates, thereby forming a stacked body of the terminal insulating film, the resin intermediate films and the glass plates; degassing the stacked body; and, after the degassing step, subjecting the stacked body to thermocompression bonding by pressing and heating up to a maximum temperature of 120 to 150° C., characterized in that: the thermal insulating film has a heat shrinkage of 0.9 to 5% in the temperature range of 120 to 150° C.; the resin intermediate film is larger in area than the glass plates; and the stacked body is formed such that an edge part of the resin intermediate film protrudes outwardly by an amount of 1 mm or more from edges of the glass plates.

More specifically, the thermal insulating film is first stacked between the two resin intermediate films. It is preferable to use a laminated film in which the thermal insulating film and the resin intermediate film have previously been bonded together for good workability. It is alternatively feasible to stack the thermal insulating film between the two resin intermediate films and bond these three films together as a laminated film before the stacking of the thermal insulating film and the resin intermediate films between the glass plates. This stacking step can be performed on the curved glass plate, on a die or on a plane.

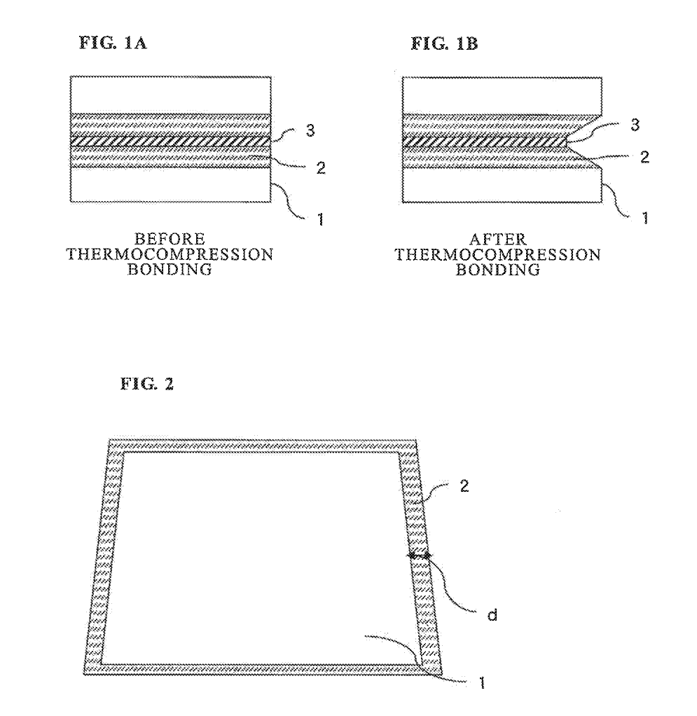

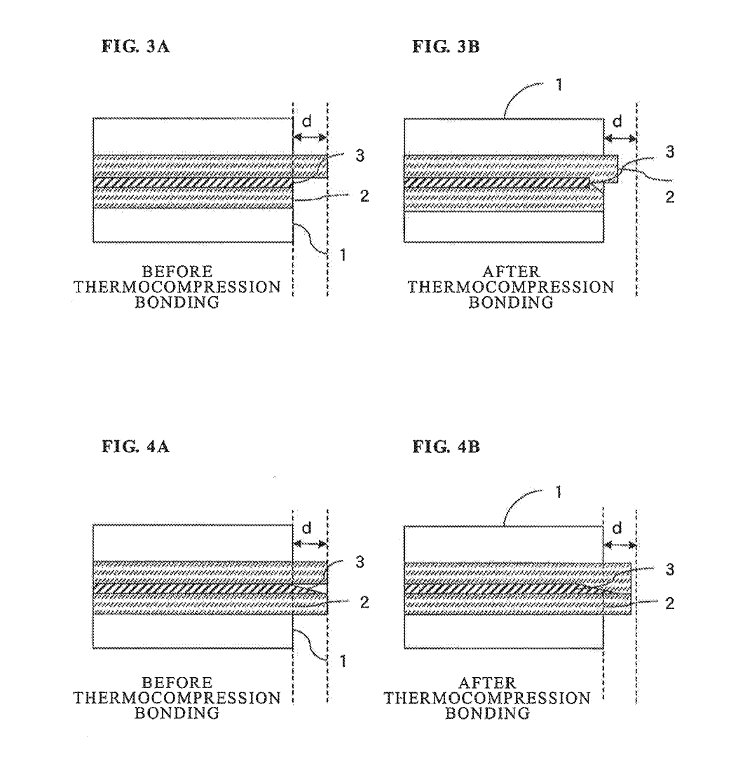

In the case where only one of the resin insulating films is larger in area than the glass plates, it is preferable in the above stacking step to place the larger resin insulating film on the upper side as shown in FIGS. 3A and 3B in the laminated film of the resin insulating film, the thermal insulating film and the resin insulating film. By placing the larger resin insulating film on the upper side, it becomes easier that, when a depression or voids appear by shrinkage of the thermal insulating film during the subsequent thermocompression bonding step (see e.g. FIG. 1B), the resin insulating film can fill in such a depression or voids.

Both of the two resin films may alternatively be made larger in area than the glass plates. In this case, it becomes possible to enhance the above-mentioned depression/void filling effects.

Preferably, a cut surface of the thermal insulating film is inclined, rather than formed at a right angle, relative to a film surface of the thermal insulating film as shown in FIGS. 4A and 4B. As the edge part of the thermal insulating film can be adequately covered by the resin intermediate film, it becomes possible to reduce the tendency for the voids to remain in the edge part of the thermal insulating film and obtain improvements in appearance and durability. There is no particular limitation on the inclination of the cut surface of the thermal insulating film. For good workability, the cut surface of the thermal insulating film is preferably inclined 30 degrees or more relative to the film surface of the thermal insulating film.

Alternatively, all of the thermal insulating film and the two resin intermediate films may be made larger in area then the glass plates. In the case where the thermal insulating film and the resin intermediate films are larger in area than the glass plates, it is preferable that the thermal insulating film and the resin intermediate films are of the same size such that the edges of the thermal insulating film and the resin intermediate films can be aligned with each other for improvement in workability. If the area of the thermal insulating film is larger than the areas of the resin insulating films, it may not be possible to prevent the occurrence of wrinkles due to deformation of a redundant part of the thermal insulating film or to prevent the formation of a depression between the edge parts of the glass plates due to too much heat shrinkage of the thermal insulating film.

As mentioned above, the stacked body is formed by stacking the thermal insulating film between the two resin intermediate films and then stacking the thermal insulating film and the resin intermediate films between the two curved glass plates. Thus, the term “stacked body” used herein generally refers to the state where the respective structural components are stacked together before being subjected to degassing.

The stacked body may alternatively be formed by successively stacking, on the glass plate, the resin intermediate film, the thermal insulating film, the resin intermediate film and the glass plate.

The resin intermediate films are stacked between the glass plates such that the edge part of the resin intermediate film protrudes outwardly by 1 mm or more from the edges of the glass plates. It suffices that the edge part of the resin intermediate film protrudes outwardly in any of the MD and TD directions in which the heat shrinkage of the thermal insulating film is 0.9 to 5% in the temperature range of 120 to 150° C. If the amount of protrusion of the resin intermediate film is less than 1 mm, it may not be possible to effectively prevent the formation of a depression or voids in the edge part of the vehicle laminated glass or may be difficult to achieve stable manufacturing of the vehicle laminated glass. The amount of protrusion of the resin intermediate film is preferably set to 3 mm or more, more preferably 5 mm or more. In this case, the edge part of the resin intermediate film becomes less likely to hang on the edges of the glass plates so that the resin intermediate film can be sufficiently supplemented relative to the heat shrinkage amount of the thermal insulating film. As mentioned above, there is no particular limitation on the upper limit of the amount of the protrusion of the resin intermediate film. For example, the amount of the protrusion of the resin intermediate film may be set to be 20 mm or less.

It is preferable that the edge parts of the thermal insulating film and the resin intermediate films protrude outwardly by 1 mm or more from the edges of the glass plates throughout the entire circumference of the stacked body. In this case, it becomes possible that the thermal insulating film and the resin insulating films can thoroughly fill in the whole area between the glass plates even when there occurs shrinkage of the thermal insulating film.

There is a tendency that the stretched film such as PET film or multilayer resin film has a higher heat shrinkage in the MD direction than in the TD direction because the stretched film is produced with the application of a tension in the MD direction. As the heat shrinkage of the stretched film are different between vertical and horizontal sides of the glass plates, it is feasible to set the amount of protrusion of the resin intermediate film on the vertical side of the glass plates different from the amount of protrusion of the resin intermediate film on the horizontal side of the glass plates.

The thermal insulating film and the resin intermediate films may have previously been cut into a desired size or may be cut after being stacked between the glass plates. In order to eliminate the need for positioning of the resin intermediate films relative to the glass plates, it is preferable to cut the thermal insulating film and the resin intermediate films after the stacking of the thermal insulating film and the resin intermediate films between the glass plates.

In other words, the manufacturing method of the vehicle laminated glass preferably includes, after stacking the thermal insulating film and the resin intermediate films between the glass plates, cutting the resin intermediate films into a desired shape. The term “desired shape” used herein refers to the shape by which the resin insulating film is larger in area than the glass plates such that the edge part of the resin insulating film protrudes outwardly by 1 mm or more from the edges of the glass plates. The upper limit of the amount of protrusion of the resin intermediate film can be adjusted as appropriate in such a manner that the resin intermediate film does not hang down from the stacked body as mentioned above.

After the formation of the stacked body, the spaces between the respective structural components of the stacked body are degassed. The degassing step can be performed by any process depending on the amount of protrusion of the resin intermediate film. It is feasible to degas the stacked body by attaching a tube of rubber resin around the stacked body and discharging air from the resin tube through an exhaust nozzle or by placing the stacked body in a vacuum bag and discharging air from the vacuum bag through an exhaust nozzle.

In the case where the degassing step is performed by placing the stacked body in the vacuum bag, the stacked body is placed in such a manner that the resin intermediate film does not become bent in the vacuum bag. The amount of protrusion of the resin intermediate film may preferably set to be 20 mm or less, more preferably 15 mm or less, although there is no particular limitation on the upper limit of the amount of protrusion of the resin intermediate film as mention above. In the case where the degassing step is performed by attaching the resin tube around the stacked body, the resin intermediate film may be bent due to too much protrusion and causes an obstacle to the degassing of the stacked body. It is thus conceivable to process the resin intermediate film or increase the width of the tube such that the resin intermediate film does not become bent by the tube. For example, the width of the tube can preferably be set to be 8 mm or smaller, preferably 5 mm or smaller, so as not to interfere with the degassing of the stacked body by bending of the resin intermediate film.

It is accordingly a preferred example of the manufacturing method of the vehicle laminated glass according to the first embodiment to, after the formation of the stacked body, fit an exhaust member on the stacked body in such a manner as to cover a circumferential edge portion of the stacked body by the exhaust member, exhaust air from the stacked body through the exhaust member, heat the stacked body at 100° C. or lower, and then, thermocompression bonding the stacked body by pressing while heating up to 120 to 150° C., wherein the stacked body is formed such that the edge part of the resin intermediate film protrudes outwardly by 1 to 20 mm from the edges of the glass plates.

The exhaust member used herein refers to the above-mentioned vacuum bag or rubber resin tube etc. It becomes possible to prevent poor degassing by enclosing the whole of the stacked body in the exhaust member or attaching the exhaust member around the whole of the circumferential edge portion of the stacked body. Further, it is preferable to subject the stacked body to preliminary bonding by heating at 60 to 100° C. after the degassing step in order to obtain good vehicle laminated glass in the subsequent thermocompression bonding step.

The vehicle laminated glass is obtained by thermocompression bonding the stacked body after degassing the stacked body by the above degassing step. The thermocompression bonding step is preferably performed by pressing and heating with the use of an autoclave. In the case of using the autoclave, it is feasible to obtain the vehicle laminated glass by heating the inside of the autoclave up to the maximum temperature of 120 to 150° C. and maintaining the inside of the autoclave at around the maximum temperature for 20 to 40 minutes. At this time, the pressing is carried out with the application of a pressure of 0.9 to 1.5 MPa. There is no particular limitation on the pressing time. For example, the pressing time may preferably be set to 30 to 100 minutes. The pressing and the heating can be carried out simultaneously or successively in any order. As the heat-shrinkable thermal insulating film is used to prevent the occurrence of wrinkles between the edge parts of the glass plates, it is preferable to carry out the heating in advance or simultaneously with the pressing such that the heat shrinkage of the thermal insulating film would not be interfered with during the heating. Alternatively, the pressing may be started in the middle of the heating.

Furthermore, it is preferable to cut off and remove the parts of the thermal insulating film and the resin intermediate films protruding from the edges of the vehicle laminated glass after the thermocompression bonding step. The application of a light or heat to the protruding parts of the thermal insulating film and the resin intermediate films can coloring or deterioration of the laminated glass. The cutting/removing is preferably carried out after the temperature is lowered to about room temperature. The resin intermediate films may get deformed to cause an appearance defect if the cutting/removing is carried out at a temperature higher than the glass transition temperature of the resin intermediate films.

The manufacturing method of the vehicle laminated glass according to a second embodiment of the present invention will be next described below.

The second embodiment is different from the first embodiment in that, after the formation of the stacked body, the stacked body is heated and then degassed by pressing with the use of rolls. Hereinafter, only the differences between the first and second embodiments will be explained below.

The manufacturing method of the vehicle laminated glass according to the second embodiment of the present invention includes: stacking the thermal insulating film between the two resin intermediate films; stacking the thermal insulating film and the resin intermediate films between the two curved glass plates, thereby forming a stacked body of the terminal insulating film, the resin intermediate films and the glass plates; degassing the stacked body; and, after the degassing step, subjecting the stacked body to thermocompression bonding by pressing and heating up to a maximum temperature of 120 to 150° C., characterized in that: the manufacturing method further includes, after forming the stacked body, heating the stacked body at 100° C. or lower; the degassing of the stacked body is performed by means of rolls after the heating and before the thermocompression bonding; the thermal insulating film has a heat shrinkage of 0.9 to 5% in the temperature range of 120 to 150° C.; the resin intermediate film is larger in area than the glass plates; and the stacked body is formed such that: an edge of the resin intermediate film in a transfer direction relative to the rolls protrudes outwardly by an amount of 1 to 10 mm from corresponding edges of the glass plates; and edges of the resin intermediate film in any directions other than the transfer direction protrude outwardly by an amount of 1 to 20 mm from corresponding edges of the glass plates.

In the second embodiment, the heating step is performed to heat the stacked body at 100° C. or lower after the formation of the stacked body. In this heating step, the resin intermediate films of the stacked body are softened by heating the stacked body at 100° C. or lower with the use of a heating device, e.g., heating furnace such that the stacked body is simultaneously subjected to degassing and preliminary bonding by pressing in the subsequent degassing step. Preferably, the whole of the stacked body is heated so as to secure uniform preliminary bonding. The heating temperature is set to be 100° C. or lower. If the heating temperature is higher than 100° C., there may occur a defect due to too much heat shrinkage of the thermal insulating film. The heating temperature may preferably be set to be 95° C. or lower. There is no particular limitation on the lower limit of the heating temperature as long as the resin intermediate films can be changed to a desired state. For example, the heating temperature may be set to 50° C. or higher, preferably 60° C. or higher.

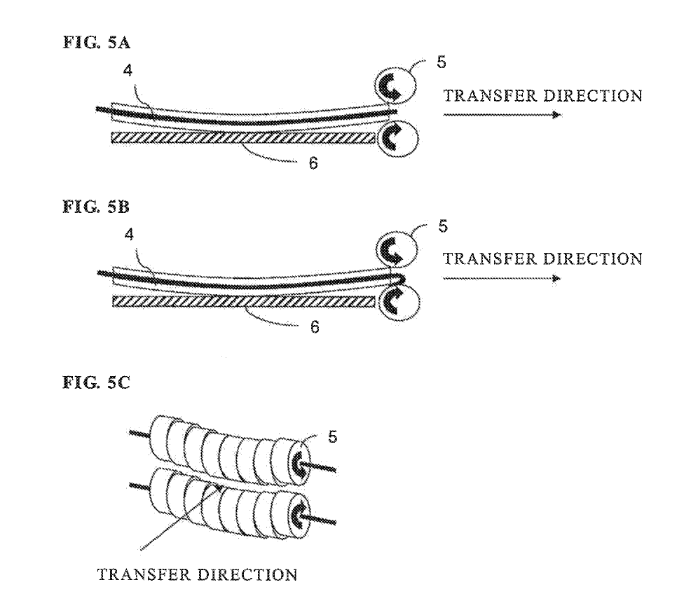

The preliminary bonding is carried out by, after the heating step, pressing the stacked body with the rolls and thereby degassing the stacked body. The preliminary bonding is effective in preventing the occurrence of wrinkles or the entry of air or oil during the subsequent thermocompression bonding step. It becomes possible to obtain good vehicle laminated glass by the adoption of such preliminary bonding. At this time, the rolls 5 are preferably arranged to sandwich the stacked body 4 from the upper and lower sides as shown in FIG. 5A, that is, apply a pressure to the stacked body 4 from the upper and lower sides. It is herein noted that, in FIGS. 5A, 5B and 5C, the vertically upper and lower sides relative to the surfaces of the glass plates transferred between the rolls are referred to as “upper” and “lower”, respectively. The stacked body 4 is preferably transferred through between the rolls 5 without cooling. For improvement in workability, it is preferable to place the stacked body 4 on a transfer device 6 as shown in FIG. 5A. It is also preferable to place the stacked body with a convex side of the stacked body directed to the lower side for easy transfer of the stacked body through between the rolls.

As the glass plates are three-dimensionally curved for vehicle use, the stacked body may not be pressed uniformly depending on the shape of the rolls. It is thus preferable to use a plurality of rolls such that the rolls can follow the shape of the glass plates as shown in FIG. 5C. More specifically, the rolls can follow the shape of the glass plates by arranging the upper-side rolls and the lower-side rolls at a distance that enables the pressing of the stacked body therebetween and moving the upper- and lower-side rolls while maintaining the distance between these rolls. It is further preferable to connect each of the rolls to an air cylinder or hydraulic cylinder and separately adjust the pressures of the respective rolls in order for the rolls to follow the various shape of the glass plates.

The heating and degassing steps can be repeated assuming the above heating and degassing operations as one cycle. For example, it is feasible to perform the first heating step, the first degassing step, the second heating step and then the second degassing step. It becomes possible to prevent poor degassing by repeatedly preforming the heating and degassing steps. The heating temperature of the first heating step may be different from that of the second heating step. Preferably the heating temperature of the first heating step is set lower than that of the second heating step in order to gradually heat up the stacked body and thereby prevent poor degassing of the staked body or excessive deformation of the thermal insulating film.

In the second embodiment, a part of the resin intermediate film protruding in the transfer direction relative to the rolls is softened by heating. If the amount of protrusion of the resin intermediate film is too large, the softened part of the resin intermediate film hangs down and gets caught in the rolls or extruded to the back of the glass plate to cause an appearance defect. It is thus preferable that, in the case where the degassing step is performed by means of the rolls, one edge of the resin intermediate film in the transfer direction relative to the rolls protrudes outwardly from the corresponding edges of the glass plates by 1 to 10 mm. The edges of the resin intermediate film in any directions other than the transfer direction may preferably protrude from the corresponding edges of the glass plates by 20 mm or less, more preferably 15 mm or less. Alternatively, all of the edges of the resin intermediate film may protrude outwardly by 10 mm or less from between the glass plates.

### EXAMPLES

First, the following reference example was conducted about the appearance defect and heat shrinkage of the film.

### Reference Example

Prepared were heat-shrinkable films (PET films of 50 μm in thickness) each having a heat shrinkage as indicated by Nos. 1 to 6 in TABLE 1, PVD films (thickness: 0.38 mm) as resin intermediate films and glass plates of the same curved shape (minimum curvature radius: 0.9 m, maximum curvature radius: 1 m) having a size of 250 mm×350 mm and a thickness of 2 mm. The heat-shrinkable films were each stacked between the two glass plates via the two PVD films. Each of the resulting stacked bodies was enclosed in a vacuum bag and subjected to preliminary bonding for 20 minutes under the conditions of a vacuum degree of 90 kPa and a retention temperature of 90° C. In the stacked body, the heat-shrinkable film and the PVD films were placed on a convex surface of the lower one of the two glass plates such that none of the heat-shrinkable film and the PVD films protruded from edges of the glass plates. After the preliminary bonding, the stacked body was subjected to thermocompression bonding by heating the stacked body at a temperature of 130 to 135° C. for about 20 minutes while applying a pressure of 1.0 to 1.3 MPa to the stacked body. The thus-obtained laminated glasses were observed for the respective appearances. The observation results are indicated in TABLE 1.

In TABLE 1, the term “the amount of shrinkage of the heat-shrinkable film” refers to a distance from an edge of the heat-shrinkable film to the edges of the glass plates after the thermocompression bonding. The term “appearance defect” refers to a defect of the laminated glass seen after the thermocompression bonding. More specifically, the term “wrinkle” means that there was a wrinkle in the heat-shrinkable film; and the term “depression” means that there was a depression between the edges of the glass plates as shown in FIG. 1B. Herein, the “amount of shrinkage of the heat-shrinkable film” was determined as an average value of the shrinkage amount measurement results in each of MD and TD directions.

[Determination of Heat Shrinkage]

The heat shrinkage of the respective films was determined by the above-mentioned procedure according to JIS C 2151 (2006).

A rectangular film sample of 150 mm in length and 40 mm in width was cut out from the thermal insulating film. Using a diamond pen, reference marks were indicated at around the center of the rectangular film sample in a width direction with a distance of about 100 mm left therebetween. After that, the rectangular film sample was divided into two equal sample pieces of 150 mm×20 mm in size.

One of the sample pieces was vertically hung in a hot-air circulation thermostat oven, heated to a measurement temperature of 135° C. at a temperature increase rate of about 5° C./min, and then, maintained at the measurement temperature for about 20 minutes. The hot-air circulation thermostat oven was then opened to the air so that the heated sample piece was subjected to natural cooling at a cooling rate of about 20° C./min and maintained at room temperature for 30 minutes. The above temperature measurements were carried out with a thermocouple thermometer. The distribution of the temperature inside the hot-air circulation thermostat oven was set to within ±1° C.

The other sample piece was maintained at room temperature. The distances L1, L2 between the reference marks on the sample pieces, one of which had been maintained at room temperature and the other of which had been heated at the measurement temperature, was measured with a scanning laser microscope (“1 LM21D” manufactured by Lasertec Corporation). The heat shrinkage (%) was determined according to the following equation: (L1−L2)×100/L1.

In this measurement test, three film samples were cut out for each of the flow direction (hereinafter also referred to as “MD direction”) and the width direction (hereinafter also referred to “TD direction”) of the film; and the heat shrinkage of the film was determined as an average value of the heat shrinkage measurement results of these three film samples.

TABLE 1

| | | | Amount of | | Appearance defect | |
|---|---|---|---|---|---|---|
| | | | shrinkage [mm] | | ◯: not occurred, | |
| | Heat | | of heat- | | Δ: slightly occurred | |
| | shrinkage [%] | | shrinkable film | | X: occurred | |
| No. | MD | TD | MD | TD | Wrinkle | Depression |
| 1 | 0.2 | 0.1 | 0.0 | 0.0 | X | ◯ |
| 2 | 0.6 | 0.6 | 0.0 | 0.0 | Δ | ◯ |
| 3 | 1.2 | 0.9 | 1.0 | 0.5 | ◯ | Δ |
| 4 | 2.2 | 1.6 | 2.0 | 1.5 | ◯ | X |
| 5 | 3.2 | 2.5 | 3.0 | 2.0 | ◯ | X |
| 6 | 4.3 | 3.6 | 3.5 | 3.0 | ◯ | X |

It is apparent from TABLE 1 that, the higher the heat shrinkage of the heat-shrinkable film, the larger the amount of shrinkage of the heat-shrinkable film although the heat-shrinkable film can conventionally be protected from wrinkle defects. It is also apparent that there occurs a hollow in the edge part of the laminated glass as the heat shrinkage becomes high.

In view of these reference examples, the following examples and comparative examples were conducted.

### Example 1

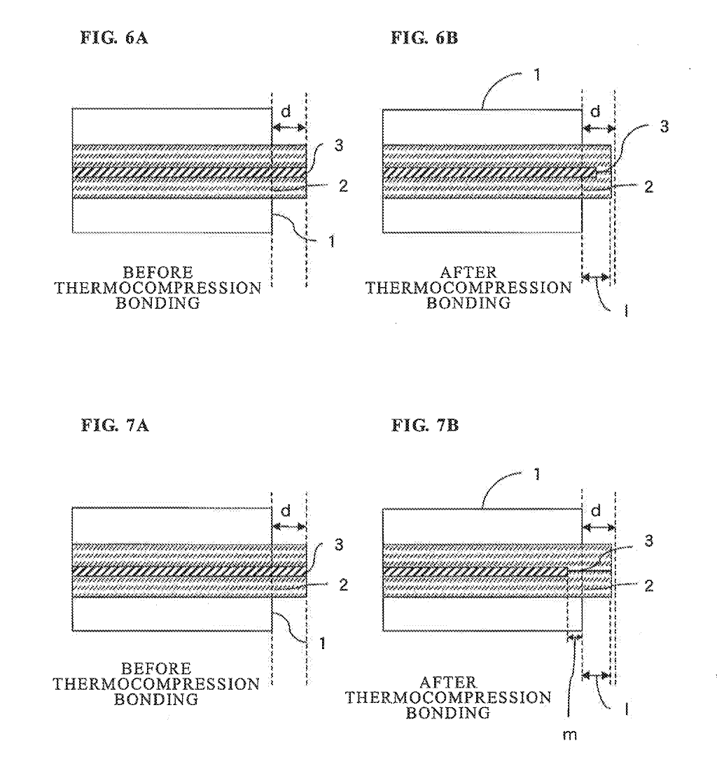

Laminated glasses were manufactured in the same manner as in Reference Example, except that: thermal insulating films indicated by Nos. 7 to 12 in TABLE 2 were used and each stacked between two upper and lower resin intermediate films such that the resulting stacked body had an edge part as shown in FIG. 6A. The thermal insulating films herein used were PET films of 50 μm in thickness having thereon infrared reflective coatings formed with alternating SiO₂- and TiO₂-based layers. In this example, each of the stacked bodies was formed such that all of edges of the thermal insulating film and edges of the two upper and lower resin intermediate films were aligned with each other and protruded by a protrusion amount (d) of 3 mm from edges of the glass plates throughout the entire circumference, and then, subjected to thermocompression bonding. The thus-obtained laminated glasses were observed for the respective appearances. In any of the test samples, there was no depression between the edges of the glass plates as shown in FIG. 6B. After the thermocompression bonding, all of the edges of the thermal insulating film and the two upper and lower resin intermediate films were located outside of the edges of the glass plates. The thermal insulating film and the resin insulating films did not get inside the glass plates in any of the test samples.

A laminated glass was also manufactured in the same manner as in Reference Example, except that: used were a laminated film of polarizing liquid crystal layers (thickness: 50 μm, heat shrinkage: 1.5%) as a thermal insulating film and two glass plates of the same curved shape (minimum curvature radius: 0.9 mm, maximum curvature radius: 1.2 mm) having a size of 262 mm×328 mm and a thickness of 2 mm; and the stacked body was formed such that all of edges of the thermal insulating film and edges of the two resin intermediate films protruded by a protrusion amount of 15 mm from edges of the glass plates throughout the entire circumference as shown in FIG. 6A. In this test sample, there was no depression between the edges of the glass plates throughout the entire circumference of the laminated glass as shown in FIG. 6B. After the thermocompression bonding, all of the edges of the thermal insulating film and the resin intermediate films were located 11 mm outside of the edges of the glass plates.

In TABLE 2, the term “heat shrinkage” refers to that measured in the same manner as in Reference Example at a measurement temperature of 135° C. Further, the term “l” in TABLE 2 refers to a distance from the edges of the glass plates to the edges of the resin intermediate films after the thermocompression bonding as shown in FIGS. 6A and 6B where the + sign means that the edges of the resin intermediate films were located outside of the edges of the glass plates. The distance l was herein determined as its average value throughout the entire circumference of the glass.

TABLE 2

| | | | Distance [mm] from edges of | |
|---|---|---|---|---|
| | Heat | | glass plates after thermocompression | Appearance |
| | shrinkage | d | bonding | defect |
| No. | [%] | [mm] | l (to edges of resin intermediate films) | (depression) |
| 7 | 0.9 | 3 | +1.5 | none |
| 8 | 1.2 | 3 | +1.0 | none |
| 9 | 1.6 | 3 | +2.0 | none |
| 10 | 2.2 | 3 | +1.5 | none |
| 11 | 3.6 | 3 | +0.5 | none |
| 12 | 4.3 | 3 | +0.5 | none |
| 13 | 3.5 | 15 | +11 | none |

### Example 3

Laminated glasses were manufactured in the same manner as in Example 1, except that: used were thermal insulating films indicated by Nos. 14 and 15 in TABLE 3; and the protrusion amount (d) of the thermal insulating film and the resin intermediate films from the edges of the glass plates was set to 1.5 mm. The thermal insulating films herein used were laminated films of 110 μm in thickness having a plurality of PET and PET copolymer layers laminated together. The thus-obtained laminated glasses were observed for the respective appearances. In any of the test samples, there was no depression between the edges of the glass plates as shown in FIG. 7B.

In TABLE 3, the term “heat shrinkage” refers to that measured in the same manner as in Reference Example at a measurement temperature of 150° C. The term “l” in TABLE 3 refers to a distance from the edges of the glass plates to the edges of the resin intermediate films after the thermocompression bonding where the + sign means that the edges of the resin intermediate films were located outside of the edges of the glass plates. Further, the term “m” in TABLE 3 refers to a distance from the edges of the glass plates to the edge of the thermal insulating film after the thermocompression bonding where the + sign means that the edge of the thermal insulating film was located outside of the edges of the glass plates: and the − sign means that the edge of the thermal insulating film was located inside of the edges of the glass plates. The distances l and m were each determined as its average value throughout the entire circumference of the glass

As shown in TABLE 3, each of the thermal insulating films of Nos. 14 and 15 was located inside the glass plates after the thermocompression bonding when the protrusion amount (d) was small before the thermocompression bonding. It has thus been shown that, even when the edge of the thermal insulating film is located inside of the glass plates, the outwardly protruding edges of the resin intermediate films fill in between the glass plates to prevent the occurrence of a depression between the edges of the glass plates.

TABLE 3

| | | | Distance [mm] from edges of | | |
|---|---|---|---|---|---|
| | | | glass plates after thermocompression | | |
| | | | bonding | | |
| | Heat | | l (to edges of | m (to edge | Appearance |
| | shrinkage | d | resin intermediate | of thermal | defect |
| No. | [%] | [mm] | films) | insulating film) | (depression) |
| 14 | 2.9 | 1 | 0 | −0.5 | none |
| | | 5 | +3.0 | +3.0 | none |
| 15 | 3.8 | 1 | 0 | −0.5 | none |
| | | 5 | +2.5 | +2.5 | none |
| 16 | 2.9 | 0 | — | −1.5 | hollow |
| 17 | 3.8 | 0 | — | −2.0 | hollow |

### Comparative Example 1

Laminated glasses were manufactured in the same manner as in Example 2, except that: used were thermal insulating films indicated by Nos. 16 and 17 in TABLE 3; and the protrusion amount (d) of the thermal insulating film and the resin intermediate films from the edges of the glass plates was set to 0 mm. The thermal insulating films herein used were laminated films of 110 μm in thickness having a plurality of PET and PET copolymer layers laminated together as in the case of Example 2. The thus-obtained laminated glasses were observed for the respective appearances. In each of the test samples, the thermal insulating film was located inside the glass plates so that there was formed a depression between the edges of the glass plates. The distance (l) from the edges of the glass plates to the edges of the resin intermediate films after the thermocompression bonding was not measured accurately because the edges of the resin intermediate films were located inside the glass plates. For this reason, the distance (l) is indicated by “-” in TABLE 3.

### Example 3

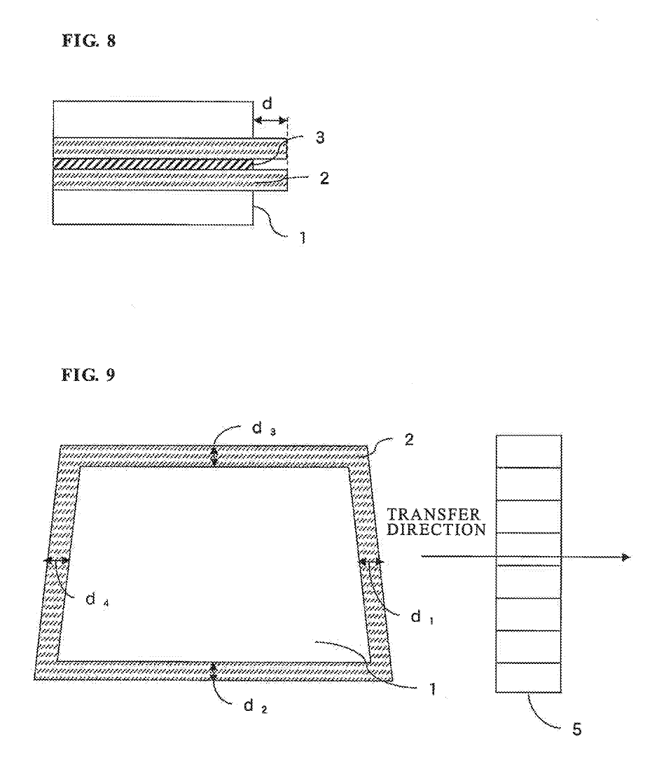

Laminated glasses were manufactured in the same manner as in Example 1, except that: used were thermal insulating films indicated by Nos. 18 and 19 in TABLE 4; and each of the stacked bodies was formed such that edges of the thermal insulating film and the glass plates were aligned with each other whereas edges of the two resin intermediate films protruded by 3 mm from the edges of the glass plates as shown in FIG. 8. The thermal insulating films herein used were PET films of 50 μm in thickness having thereon infrared reflective coatings formed with alternating SiO₂- and TiO₂-based layers. In any of the test samples, there was no depression between the edges of the glass plates throughout the entire circumference of the glass. After the thermocompression bonding, the edges of the resin intermediate films were located 1 mm outside of the edges of the glass plates. The edges of the thermal insulating film were shrinked by 1 mm toward the inside of the glass plates in both of the test samples.

TABLE 4

| | | | Distance [mm] from edges of | | |
|---|---|---|---|---|---|
| | | | glass plates after thermocompression | | |
| | | | bonding | | |
| | Heat | | l (to edges of | m (to edge | Appearance |
| | shrinkage | d | resin intermediate | of thermal | defect |
| No. | [%] | [mm] | films) | insulating film) | (depression) |
| 18 | 1.2 | 3 | +1 | −1.0 | none |
| 19 | 2.2 | 3 | +1 | −1.0 | none |

### Example 4

Prepared were multilayer resin films (thickness: 70 μm) each having a heat shrinkage as indicated by Nos. 21 and 22 in TABLE 5 as thermal insulating films, PVD films (thickness: 0.38 mm) as resin intermediate films and glass plates of the same curved shape (minimum curvature radius: 1.0 m, maximum curvature radius: 2.5 m) having a size of 1300 mm×1000 mm and a thickness of 2 mm. The heat-shrinkable films were each stacked between the two glass plates via the two PVD films. The thermal insulating films herein used were laminated films of 110 μm in thickness having a plurality of PET and PET copolymer layers laminated together. In each of the resulting stacked bodies, edges of the thermal insulating film and the resin intermediate films protruded from edges of the glass plates as shown in FIG. 6A. The amounts of protrusion of the thermal insulating film and the resin intermediate films are indicated in TABLE 5. Herein, the protrusion amounts on the respective sides of the stacked body are indicated by dₗ to d₄ as shown in FIG. 9.

Each of the stacked bodies was heated at 60° C. or 90° C. for 3 to 7 minutes in a heating furnace and, without being subjected to cooling, pressed at 2 to 10 kg/cm² from the upper and lower sides with the use of rolls. In this example, the stacked body was subjected to degassing and preliminary bonding by first heating the stacked body to 60° C., pressing the stacked body with the rolls, heating the stacked body to 90° C. and then pressing the stacked body with the roll.

After the preliminary bonding, the stacked body was subjected to thermocompression bonding by heating the stacked body up to a temperature of 130 to 135° C. in an autoclave, maintaining the stacked body at the heated temperature for about 20 minutes and applying a pressure of 1.0 to 1.3 MPa to the stacked body for 40 to 60 minutes. There was seen no appearance defect such as depression in any of the thus-obtained laminated glasses.

TABLE 5

| | | | | | | Distance [mm] from edges | | | | |
|---|---|---|---|---|---|---|---|---|---|---|
| | | | | | | of glass plates after | | | | |
| | | | | | | thermocompression bonding | | | | |
| | Heat | | | | | l (to edges of resin | | | | |
| | shrinkage | d [mm] | | | | intermediate films) | | | | Appearance |
| No. | [%] | 1 | 2 | 3 | 4 | 1 | 2 | 3 | 4 | defect |
| 21 | 2.1 | 3 | 3 | 3 | 10 | +0.5 | +1 | +1 | +5 | none |
| 22 | 2.1 | 5 | 5 | 5 | 5 | +1 | +1.5 | +1.5 | +1.5 | none |
| 23 | 3.1 | 15 | 25 | 25 | 25 | +14 | +20 | +18 | +16 | film extruded |
| | | | | | | | | | | to back at d₁ |

### Comparative Example 2

A laminated glass was manufactured in the same manner as in Example 4, except that used were a thermal insulating film having a heat shrinkage as indicated by No. 23 in TABLE 5 and two glass plates of the same curved shape (minimum curvature radius: 1.0 mm, maximum curvature radius: 2.6 mm) having a size of 1200 mm×850 mm and a thickness of 2 mm.

The thus-obtained laminated glass was observed for its appearance. There was seen such a defect that, on the transfer direction side, the softened resin insulating film was extruded to the back of the glass plate in Comparative Example 2.

### DESCRIPTION OF REFERENCE NUMERALS

1: Glass plate
2: Resin intermediate film
3: Thermal insulating film
4: Stacked body
5: Roll
6: Transfer device

1.-9. (canceled)

10. A method of manufacturing a laminated glass for a vehicle, comprising:
stacking a thermal insulating film between two resin intermediate films;
stacking the thermal insulating film and the resin intermediate films between two curved glass plates, thereby forming a stacked body of the terminal insulating film, the resin intermediate films and the glass plates;
degassing the stacked body; and
after the degassing, subjecting the stacked body to thermocompression bonding by pressing and heating up to a maximum temperature of 120 to 150° C.,
wherein the thermal insulating film has a heat shrinkage of 0.9 to 5% in a temperature range of 120 to 150° C.; wherein at least one of the resin intermediate films is larger in area than the glass plates; and wherein the stacked body is formed such that an edge part of the at least one of the resin intermediate films protrudes outwardly by 1 mm or more from edges of the glass plates.

11. The method of manufacturing the laminated glass for the vehicle according to claim 10, wherein the edge part of the at least one of the resin intermediate films protrudes outwardly by 1 mm or more from the edges of the glass plates in a plurality of directions.

12. The method of manufacturing the laminated glass for the vehicle according to claim 10, wherein the thermal insulating film is larger in area than the glass plates; and wherein the stacked body is formed such that an edge part of the thermal insulating film also protrudes outwardly from the edges of the glass plates.

13. The method of manufacturing the laminated glass for the vehicle according to claim 12, wherein the thermal insulating film and both of the resin intermediate films are larger in area than the glass plates; and wherein the stacked body is formed such that the edge parts of the thermal insulating film and the resin intermediate films protrude outwardly by 1 mm or more from the edges of the glass plates.

14. The method of manufacturing the laminated glass for the vehicle according to claim 10, wherein a cut surface of the thermal insulating film is inclined 30 degrees or more relative to a film surface of the thermal insulating film.

15. The method of manufacturing the laminated glass for the vehicle according to claim 10, wherein the degassing is performed by, after the formation of the stacked body, fitting an exhaust member on the stacked body in such a manner as to cover a circumferential edge portion of the stacked body by the exhaust member and exhausting air from the stacked body through the exhaust member; wherein the method further comprises heating the stacked body at 100° C. or lower after the degassing; wherein the thermocompression bonding is performed by, after the heating, pressing the stacked body while heating the stacked body up to the maximum temperature of 120 to 150° C.; and wherein the stacked body is formed such that the edge part of the at least one of the resin intermediate films protrudes outwardly by 1 to 20 mm from the edges of the glass plates.

16. The method of manufacturing the laminated glass for the vehicle according to claim 10, wherein the method further comprises, after the forming of the stacked body, heating the stacked body at 100° C. or lower; wherein the degassing is performed by means of rolls after the heating and before the thermocompression bonding; and wherein the stacked body is so structured that: an edge of the resin intermediate film in a transfer direction relative to the rolls protrudes outwardly by 1 to 10 mm from corresponding edges of the glass plates; and edges of the resin intermediate film in any directions other than the transfer direction protrude outwardly by 1 to 20 mm from corresponding edges of the glass plates.

17. The method of manufacturing the laminated glass for the vehicle according to claim 10, wherein the forming of the stacked body includes cutting the resin intermediate films into a predetermined shape after stacking the thermal insulating film and the resin intermediate films between the glass plates.
